(19) United States
(12) Patent Application Publication
(10) Pub. No.: US 2008/0162670 A1
(43) Pub. Date: Jul. 3, 2008

(54) Automatic configuration of embedded media player

(75) Inventors: Justin F. Chapweske, Fridley, MN (US); Christopher McKinley, Minneapolis, MN (US)

Correspondence Address: SHUMAKER & SIEFFERT, P. A., 1625 RADIO DRIVE, SUITE 300, WOODBURY, MN, 55125, US

(73) Assignee: Swarmcast, Inc., Minneapolis, MN (US)

(21) Appl. No.: 11/999,262

(22) Filed: Dec. 4, 2007

Related U.S. Application Data
(60) Provisional application No. 60/868,446, filed on Dec. 4, 2006.

(51) Int. Cl. G06F 15/177

(52) U.S. Cl. 709/219

(57) ABSTRACT

In general, techniques are described of automatically configuring an embedded media player. For example, a user interface such as a web page or a user interface of a media player may include an embedded media file that is to be presented. In addition, the user interface may display an input mechanism that offers a user the opportunity to present a higher-quality version of the media file. When a client device receives the user interface and a user interacts with the input mechanism, a specialized media player is automatically downloaded to the client device. The specialized media player then automatically downloads a higher-quality version of the media file and begins playing the higher-quality version of the media file automatically. The specialized media player may obtain the higher-quality version of the media file using peer-to-peer or other download acceleration techniques.

This application claims the benefit of U.S. Provisional Application Ser. No. 60/868,446, filed Dec. 4, 2006, the entire content of which is incorporated herein by reference.

### TECHNICAL FIELD

The invention relates to computer networks, and, in particular to the use of media players on computer devices.

### BACKGROUND

The World Wide Web allows a user to access a resource (e.g., browse to a web page) that contains embedded media. Such embedded media may include audio media, video media, photographs, drawings, and so on. Streaming technology enables a web browser to start presenting the media before the web browser finishes downloading all of the media. For example, a web browser may begin playing a video stream before the web browser downloads all of the video data.

### SUMMARY

In general, the invention is directed to techniques of automatically configuring a media player embedded within a network resource. For example, a user interface, such as a web page may identify a media file that is to be presented as part of the web page. The web browser may use a user interface of a media player to present the identified media file as part of the web page. In this way, a media file may be “embedded” within the web page. In addition, a user interface such as the web page or a user interface of a media player, may display an input mechanism, such as a, for example, a link or button that offers a user the opportunity to present a higher-quality version of the media file. The input mechanism may be, for example, a link, a button, a drop down menu, a field, and the like. When a user downloads the web page to a client device and interacts with the input mechanism, such as, for example, by clicking a link or button, a specialized media player is automatically configured on the client device. For example, if the specialized media player is not installed on the client device, the specialized media player may be downloaded and installed. The specialized media player then automatically downloads a higher-quality version of the media file and begins playing the higher-quality version of the media file automatically. The higher-quality version of the media file may be obtained from a different network resource. The specialized media player may obtain the higher-quality version of the media file, for example, using peer-to-peer or other static or streaming download acceleration techniques.

In one embodiment, a method comprises presenting a user interface, such as, for example, a web page with a client device. The web page identifies a media file that is to be presented as part of the web page. In addition, the user interface such as a web page or the user interface for a media player, includes an input mechanism, for example, a link or button that offers a user an opportunity to experience a version of the media file that has higher quality than the media file. The method also comprises automatically configuring a media player on the client device when the user selects such an option by interacting with the input mechanism by for example, clicking a link or button. In addition, the method comprises automatically obtaining the higher-quality version of the media file using the media player. Further, the method comprises automatically presenting the higher-quality version of the media file using the user interface of the media player.

In another embodiment, a system comprises a client device to present a user interface, such as, for example a web page. The web page identifies a media file that is to be presented as part of the web page. In addition, the user interface, such as a web page or the user interface of a media player includes an input mechanism, such as, for example, a link or button, that offers a user an opportunity to experience a version of the media file that has higher quality than the media file. The client device automatically configures a media player on the client device when the user selects such an option by interacting with the input mechanism by for example, clicking a link or button and the client device automatically obtains the higher-quality version of the media file using the media player. The client device automatically presents the higher-quality version of the media file using the user interface of the media player.

In another embodiment, a computer-readable medium comprises instructions. The instructions cause a programmable processor to present a user interface, such as, for example a web page with a client device. The web page identifies a media file that is to be presented as part of the web page. In addition, the user interface such as the web page or the user interface of a media player, includes an input mechanism, such as, for example, a link or button, that offers a user an opportunity to experience a version of the media file that has higher quality than the media file. The instructions also cause the processor to automatically configure a media player on the client device when the user selects such an option by interacting with the input mechanism by, for example, clicking a link or button. In addition, the instructions cause the processor to automatically obtain the higher-quality version of the media file using the media player. The instructions also cause the processor to automatically present the higher-quality version of the media file using the user interface of the media player.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary system in which a media player is automatically configured on a client device.

FIG. 2 is a flowchart illustrating an exemplary operation of a system in which a media player is automatically configured on a client device.

FIG. 3 is a screen illustration showing an exemplary user interface.

FIG. 4 is a screen illustration showing an exemplary user interface in which a media player presents a higher-quality version of a media file.

### DETAILED DESCRIPTION

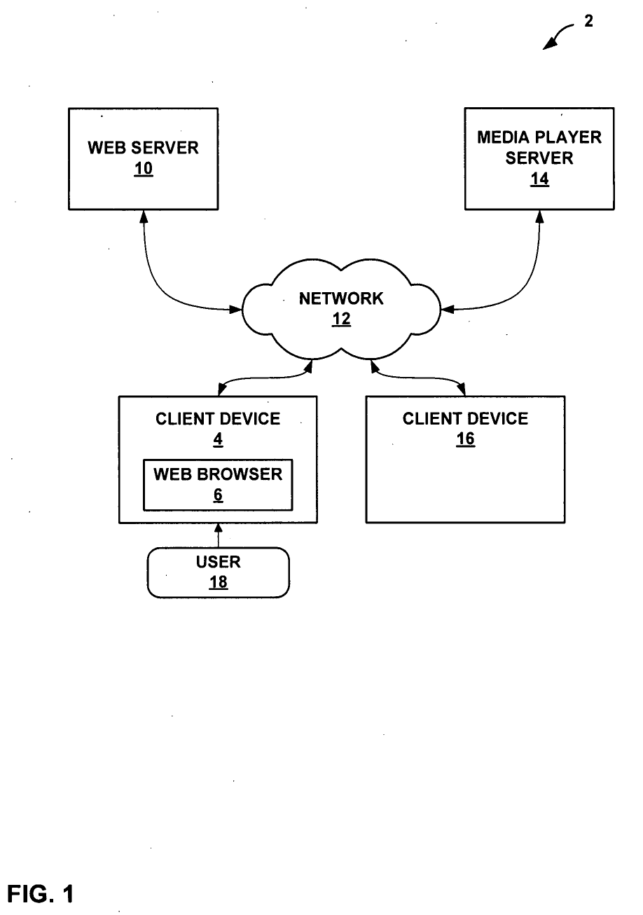

FIG. 1 is a block diagram illustrating an exemplary system 2 in which a media player is automatically configured on a client device 4. Client device 4 may be a personal computer, a gaming platform, a mobile telephone, a personal digital assistant, a handheld computer, a mainframe computer, a network workstation, television set top box, or otherwise.

For purposes of example, the techniques will be described with respect to web pages, although the techniques may be applied to other types of network resources. Initially, a user 18 of client device 4 may request that a web browser 6 on client device 4 present a web page provided by a web server 10. In response to the request from user 18, web browser 6 may send a request to web server 10 via a network 12. Network 12 may be a wide-area network such as the Internet, a local-area network (LAN), or otherwise. The request may be a Hyper-Text Transfer Protocol (HTTP) request, a HTTP Security (HTTPS) request, or otherwise. In response to the request from web browser 6, web server 10 may send to web browser 6 a response that includes the requested web page. Upon receiving the web page, web browser 6 may render and present the web page.

The web page may identify a media file that is to be presented as part of the web page. The web page may identify the media file using Hypertext Markup Language tags. For example, a web page regarding a product for sale may include text describing the product along with tags that identify an audio or video file that shows the product in operation.

In addition to the embedded media file, a user interface, such as, for example, a web page or a user interface of a media player may also include an input mechanism, such as, for example, a link or button that offers user 18 an opportunity to experience a higher-quality version of the media file. The input mechanism may be, for example, a link, a button, a drop down menu, a field, and the like. For example, the input mechanism may include the text “Click here to see this video is High-Definition.” The input mechanism may take the form of text, a graphic, or otherwise. In some example embodiments, where the input mechanism is a link or button, user 18 may select the link or button by positioning a cursor over the link or button with a mouse, trackball, or other pointing device and clicking a button. Alternatively, user 18 may select the link or button using keyboard instructions.

The input mechanism may specify a Universal Resource Locator of a media player server 14. Thus, when user 18 interacts with the input mechanism to select the higher-quality version of the media file, by for example, clicking on a link or button, web browser 6 sends a request via network 12 to media player server 14. In response to the request from web browser 6, media player server 14 determines whether a media player that is capable of downloading and playing a higher-quality version of the media file embedded on the web page is installed on client device 4 and configured to operate as a plug-in with web browser 6. If media player server 14 determines that such a media player is installed on client device 4, media player server 14 sends a redirect message to web browser 6. The redirect message instructs web browser 6 to automatically send a request for the higher-quality version of the media file to a server on network 12 that provides some or all of the higher-quality version of the media file. For example, media player server 14 may send a HTTP redirect message to web browser 6. Subsequently, the media player requests the higher-quality version of the media file and may begin presenting the higher-quality version of the media file. In some instances, the media player may open a new window to play the higher-quality version of the media file. For instance, the new window may occupy the entire screen. The higher-quality version of the media file may have a higher resolution or size, include less compression, have a higher number of frames per second, and so on. For example, a higher-quality version of a video file may have a resolution comparable to that of video on a high-definition television.

In some embodiments, the media player may begin to download the higher-quality version of the media file as soon as web page is first loaded on client device 4. In other words, the media player loaded on client device 4 may scan the web page, identify tags that identify the higher-quality media file, and “pre-fetch” the higher-quality version of the media file before user 18 interacts with the input mechanism to select the higher quality version of the media file. In this way, the media player may present the higher-quality version of the media file more quickly in the event user 18 interacts with the input mechanism to select the higher quality version of the media file.

On the other hand, if media player server 14 determines a media player that is capable of downloading and playing the higher-quality version of the media file is not installed on client device 4 or configured to operate as a plug-in with web browser 6, media player server 14 may automatically configure the media player on client device 4. For example, media player server 14 may send one or more installation files to client device 4. When client device 4 receives the installation files, client device 4 may prompt user 18 to indicate whether the user consents to the installation of the media player. For instance, client device 4 may automatically launch an installation wizard that prompts user 18 to agree to an end-user license agreement. In some example embodiments, the wizard may also prompt user 18 to provide an email address, to check boxes regarding consumer interests, and so on. If user 18 indicates that it does not consent to the installation of the media player, the media player is not installed in on client device 4. Otherwise, the media player server 14 automatically installs and configures the media player on client device 4. In this way, web browser 6 is not redirected to a separate web page from which user 18 may select a link to download a media player. Rather, the web browser 6 may continue to present the same web page. Thus, after user 18 interacts with the input mechanism to select a higher quality version of the media file, by for example selecting a link or button, the only action required by user 18 to view the higher quality version of the media file is providing an indication of consent to the installation of the media player.

After the media player is installed on client device 4, the media player may automatically begin downloading the higher-quality version of the media file. To download the higher-quality version of the media file, the media player may use one or more download acceleration techniques. For example, the media player may use a peer-to-peer technology to download the higher-quality version of the media file. When the media player uses a peer-to-peer technology to download a file, the media player downloads all or portions of the file from one or more peer nodes (e.g., other client devices). For instance, the media player may use “swarming” technology provided by Swarmcast, Inc. of Minneapolis, Minn. In general, the media player initiates a “swarming” download by sending a request to a server that is an initial source of the higher-quality version of the media file. For instance, the media player may send a request to web server 10. In response to the request, the server sends a first section of the media file to the media player. However, rather than sending the entire media file to the media player, the server breaks the media file into small sections and begins sending some of these sections to the media player. Meanwhile, a second client device 16 may begin its download process by also contacting the server. The server then sends client device 16 sections of the media file, but sections that are different than the sections sent to client device 4. Simultaneously, client device 4 may begin sending some of the sections of the media file it received to client device 16 and client device 16 may begin sending to client device 4 some of the sections of the media file it has already received. In this way, media players on both client device 4 and client device 16 may begin playing the media file faster than if either of client device 4 or client device 16 had downloaded the media file exclusively from web server 16.

Otherwise stated, “swarming” may be described as a network encoding method of using a computer for transferring data. This method comprises sending a request for data from a requesting computer to a targeted computer system. In addition, the method comprises accessing at the targeted computer system a look-up list to identify other computers that have previously requested and downloaded at least a portion of the requested data. The method also includes sending requests to the identified computers, wherein upon receiving the requests the identified computers have received different partial portions of the requested data and independently encoding the different partial portions of the data at the identified computers in response to the requests. Furthermore, the method includes sending the encoded different partial portions of the data from the identified computers to the requesting computer and completing the download of the remaining portions of the data with the identified computers. The method also includes receiving, with the requesting computer, the different partial portions of the encoded data from at least two of the sending computers. In addition, the method includes decoding the received encoded data to recreate the requested data from the different partial portions and saving the requested data in memory. This process of downloading files using “swarming” technology is described in greater detail in U.S. Pat. No. 7,277,950 entitled “APPARATUS, METHOD AND SYSTEM FOR AN ACKNOWLEDGEMENT INDEPENDENT EQUALIZED DATA PACKET TRANSFER MECHANISM OVER A PEER TO PEER NETWORK,” the entire content of which is hereby incorporated by reference.

Other exemplary peer-to-peer technologies include receiving data over multiple channels in parallel with data order prioritization. A more complete description of this technology is described in co-pending U.S. patent application Ser. No. 10/788,695 entitled “PARALLEL DATA TRANSFER OVER MULTIPLE CHANNELS WITH DATA ORDER PRIORITIZATION,” the entire content of which is hereby incorporated by reference.

The media player may download the entire higher-quality version of the media file and then begin to present the higher-quality version. Alternatively, the media player may begin presenting the higher-quality version while client device 4 is still receiving the higher-quality version. In some instances, the media file may include an advertisement prior to the actual media file. For example, the media player may present a commercial advertisement first and then present a requested video.

After the media player begins downloading the higher-quality version of a video file, the media player may open a new window in web browser 6 that appears in front of the window of web browser 6 that presents the web page. The new browser window may present the video file along with one or more buttons to control the presentation (e.g., play, pause, rewind, fast-forward, etc.). This new browser window may occupy the entire viewable area of a computer or television monitor. The web page in the existing window of web browser 6 may remain the same. Because the web page in the existing window may remain the same, user 18 may use the web page in the existing window to easily navigate to other web pages or to interact with the input mechanism to select another web page that offers the opportunity to experience a higher-quality version of another media file.

This invention may provide one or more advantages. For example, the invention may provide a superior experience for users. For example, a media player may be automatically installed and configured without required that the user navigate to a separate web page. When a user is required to navigate to a separate web page, the user may lose interest and navigate away from the web page. Consequently, a provider of the web page may lose business and/or advertising revenue. Furthermore, because the media player may utilize one or more download acceleration techniques, the media player may download a higher-quality version of a media file in an equivalent amount of time that it may take to download a lower-quality version of the media file. In addition, the higher-quality version of the media file may provide a more compelling experience for the user. As a result, the user may stay longer at the web page and may be more likely to purchase a product from the web page.

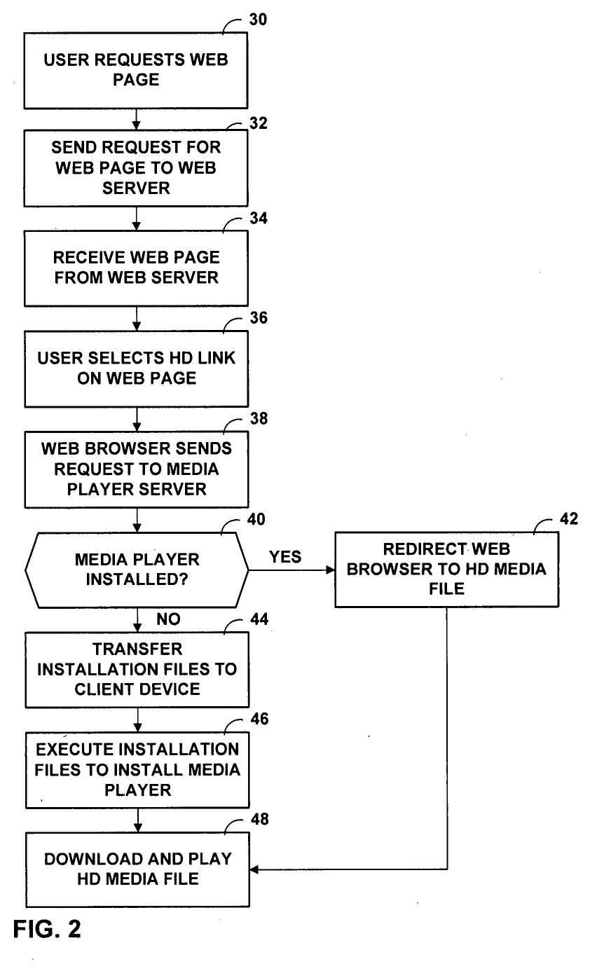

FIG. 2 is a flowchart illustrating an exemplary operation of a system in which a media player is automatically configured on a client device. Initially, user 18 may request a network resource user interface, e.g., a web page (30). For example, user 18 may enter a universal resource locator (URL) of the web page in an address bar of web browser 6 or may use web browser 6 to interact with an input mechanism to select a URL of the web page. User 18 may interact with an input mechanism to select the URL of the web page by, for example, selecting a link or button that points to the URL of the web page. Web browser 6 may then send a request for the web page to web server 10 (32). In response to the request, web server 10 may send the requested web page to web browser 6 and the web browser may receive the web page (34). The web page includes one or more tags that identify a media file that is to be presented as part of the web page. For example, the identified media file may be a Flash Video file playable by a Flash Video player available from Abode Systems Inc. of San Jose, Calif., a QuickTime video file playable by a QuickTime video player available from Apple Computer of Cupertino, Calif., or otherwise.

After receiving the web page, user 18 may interact with the input mechanism on a user interface, such as a web page, or a user interface of a media player to offer the user the opportunity to experience (e.g., view, hear, etc.) the media file in “High-Definition” (36). User 18 may interact with the input mechanism on a user interface, such as a web page, or a user interface of a media player by for example, selecting a link or button on the web page or in the user interface of the media player that offers the user the opportunity to experience the media file in “High-Definition.” In an exemplary embodiment, where the input mechanism comprises a link or button on a user interface such as a web page or a user interface of the media player, when user 18 selects the link or button, web browser 6 sends a request to media player server 14 (38). In response to the request, media player server 14 determines whether a media player capable of downloading and presenting the “high definition” version of the media file is installed on client device 4 (40). If the media player is already installed on client device 4 (“YES” of 40), media player server 14 sends a redirection message to web browser 6 (42). The redirection message causes web browser 6 to send a new request to a location where media player may download and play a high definition version of the media file (48). Alternatively, if the media player is not yet installed on client device 4 (“NO” of 40), media player 14 automatically transfers one or more installation files to client device 4 (44). Client device 4 may optionally confirm that user 18 would like to install the media player. If so, client device 4 executes the installation files and installs the media player (46). After the media player is installed, the media player may download and play a high definition version of the media file (48).

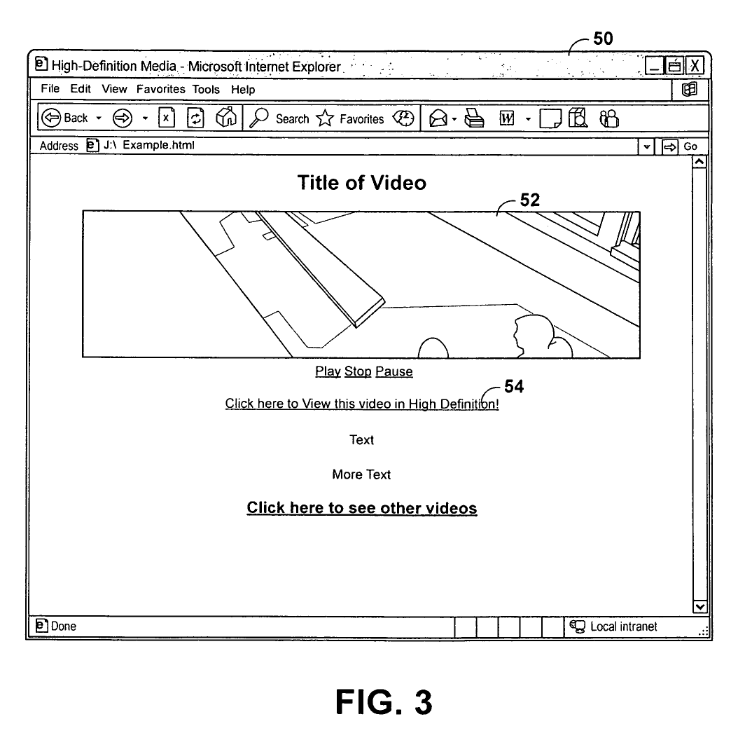

FIG. 3 is a screen illustration showing an exemplary user interface 50. User interface 50 includes a media file 52 and some text describing the media file. In addition, user interface 50 includes a link or button 54 with the caption “Click here to view this video in High Definition!” When a user selects link or button 54, the media player may be automatically configured on the client device and the media player may begin to present a higher-quality version of media file 52.

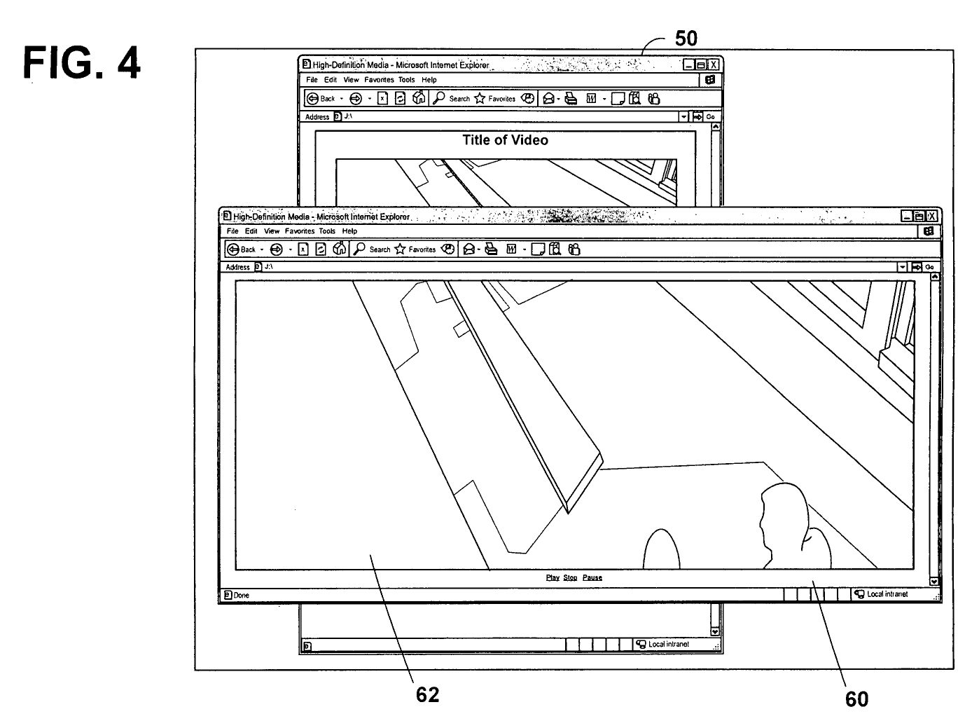

FIG. 4 is a screen illustration showing an-exemplary user interface 60 in which a media player presents a higher-quality version of a media file 62. As illustrated in the example of FIG. 4, the higher-quality version of media file 62 may be larger. The example of FIG. 4 also illustrates that interface 50 may remain in the background while the media player presents higher-quality version of the media file 62.

Various embodiments of the invention have been described. These and other embodiments are within the scope of the following claims.

1. A method comprising:
presenting a user interface with a client device, wherein the user interface includes an embedded media file that is to be presented, and wherein the user interface includes an input mechanism that offers a user an opportunity to experience a version of the embedded media file that has higher quality than the media file embedded within the user interface;
automatically configuring a media player on the client device when the user interacts with the input mechanism to select the version of the embedded media file that has higher quality that the embedded media file;
automatically obtaining the higher-quality version of the media file using the media player; and
automatically presenting the higher-quality version of the media file using the media player.

2. The method of claim 1, wherein presenting a user interface comprises presenting a web page with a web browser.

3. The method of claim 1, wherein presenting a user interface comprises presenting a user interface of the media player executing on the client device.

4. The method of claim 1, wherein an input mechanism comprises at least one of a link and button.

5. The method of claim 1, wherein automatically configuring a media player comprises:
sending an installation file to the client device; and
executing the installation file to install the media player.

6. The method of claim 1, wherein the method further comprises:
determining, with a media player server, whether the media player is configured on the client device; and
redirecting the client device to a location where the higher-quality version of the media file is obtainable.

7. The method of claim 6, wherein the method further comprises downloading the higher-quality version with the media player before the user interacts with the input mechanism.

8. The method of claim 1, wherein automatically obtaining and presenting the higher-quality version comprises downloading the higher-quality version from a plurality of peer nodes.

9. The method of claim 8, wherein downloading the higher-quality version from a plurality of peer nodes comprises receiving data over multiple channels in parallel with data order prioritization.

10. The method of claim 8, wherein downloading the higher-quality version from a plurality of peer nodes comprises:
sending a request for data from the client device to a targeted computer system;
accessing at the targeted computer system a look-up list to identify other computers that have previously requested and downloaded at least a portion of the requested data;
sending requests to the identified computers, wherein upon receiving the requests the identified computers have received different partial portions of the requested data;
independently encoding the different partial portions of the data at the identified computers in response to the requests;
sending the encoded different partial portions of the data from the identified computers to the client device and completing the download of the remaining portions of the data with the identified computers;
receiving, with the client device, the different partial portions of the encoded data from at least two of the sending computers;
decoding the received encoded data to recreate the requested data from the different partial portions; and
saving the requested data in memory.

11. The method of claim 1, wherein presenting the higher-quality version comprises opening a new window to present the higher-quality version.

12. The method of claim 2, wherein the web page includes text.

13. A system comprising:
a client device to present a user interface, wherein the user interface includes an embedded media file that is to be presented, and wherein the user interface includes an input mechanism that offers a user an opportunity to experience a version of the media file that has higher quality than the embedded media file;
wherein the client device automatically configures a media player on the client device when the user interacts with the input mechanism to select the version of the embedded media file that has higher quality than the embedded media file;
wherein the client device automatically obtains the higher-quality version of the media file using the media player; and
wherein the client device automatically presents the higher-quality version of the media file using the media player.

14. The system of claim 13, wherein the user interface includes a web page presented by a web browser.

15. The system of claim 13, wherein the user interface includes a user interface of the media player executing on the client device.

16. The system of claim 13, wherein the input mechanism comprises at least one of a link and button.

17. The system of claim 13, wherein the client device automatically configures a media player by receiving an installation file from a media player server and executing the installation file to install the media player.

18. The system of claim 13, wherein the client device automatically obtains the higher-quality version of the media file by downloading the higher-quality version of the media file from a plurality of peer nodes.

19. The system of claim 13, wherein the client device automatically obtains the higher quality version of the media file by downloading the higher-quality version from a plurality of peer nodes over multiple channels in parallel with data order prioritization.

20. A computer-readable medium comprising instructions, the instructions causing a programmable processor to:
present a user interface with a client device, wherein the user interface includes an embedded media file that is to be presented, and wherein the user interface includes an input mechanism that offers a user an opportunity to experience a version of the embedded media file that has higher quality than the embedded media file;
automatically configure a media player on the client device when the user interacts with the input mechanism to select the version of the embedded media file that has a higher quality than the embedded media file;
automatically obtain the higher-quality version of the media file using the media player; and
automatically present the higher-quality version of the media file using the media player.

21. A method comprising:
presenting a web page with a client device, wherein the web page identifies an embedded media file that is to be presented as part of the web page, and wherein the web page includes a link that offers a user an opportunity to experience a version of the embedded media file that has higher quality than the embedded media file;
automatically configuring a media player on the client device when the user selects the link;
automatically obtaining the higher-quality version of the media file using the media player; and
automatically presenting the higher-quality version of the media file using the media player.

22. A system comprising:
a client device to present a web page, wherein the web page identifies a media file that is to be presented as part of the web page, and wherein the web page includes a link that offers a user an opportunity to experience a version of the media file that has higher quality than the media file;
wherein the client device automatically configures a media player on the client device when the user selects the link;
wherein the client device automatically obtains the higher-quality version of the media file using the media player; and
wherein the client device automatically presents the higher-quality version of the media file using the media player.
